(19) United States
(12) Patent Application Publication
(10) Pub. No.: US 2011/0227334 A1
(43) Pub. Date: Sep. 22, 2011

(54) ROTARY UNION

(75) Inventors: Rudiger Grimmel, Netphen (DE); Christoph Sundermann, Hilchenbach (DE); Uwe Berkholz, Betzdorf (DE)

(73) Assignee: SMS SIEMAG AKTIENGESELLSCHAFT, Dusseldorf (DE)

(21) Appl. No.: 13/129,307

(22) PCT Filed: Nov. 12, 2009
(86) PCT No.: PCT/EP09/08075

§ 371 Date: May 13, 2011

(30) Foreign Application Priority Data
Nov. 13, 2008 (DE) 10 2008 057 265.9
Jun. 3, 2009 (DE) 10 2009 023 741.0

(51) Int. Cl. F16L 27/087

(52) U.S. Cl. 285/272

(57) ABSTRACT

The invention relates to a rotary union for supplying and/or discharging a medium under pressure into or out of an axial cavity of a rotating machine part, comprising a union part (12), which does not rotate and is fixed relative to the device, a rotary union part (15) and with bearing means as well as sealing components, which act in a radial sealing plane between the rotary union part (15) and the union part (12) fixed relative to the device. The rotary union is characterized in that the bearing means comprise individual step bearings (13, 14), which fix the radial distance between the union part (12) fixed relative to the device and the rotary union part (15).

The invention relates to a rotary union for supplying and/or removing a pressurized medium into or from an axial hollow space of a rotating machine part with a non-rotating union part, which is fixed to the device, a rotating union part, and with bearing means as well as sealing means which are effective in a radial sealing plane between the rotating union part and the non-rotating union part.

Rotary unions generally comprise a non-rotating union part fixed to the devices and a union part which rotates together with the rotating machine part, wherein sealing means are arranged between the non-rotating union part and the rotating union part. Such a rotary union is used for supplying rolls or rollers with cooling means which essentially constitute axes or shafts whose ends are supported by bearings. Under the heavy load, these rotating machine parts are subjected to a certain axial bending which leads to so-called angle errors at the ends of the axes or shafts. The angle error constitutes a displacement and tilting of the radial end surfaces of the rotating machine part and, thus, also of the rotating rotary union part if the latter is fixedly connected to the rotating machine part. This leads to sealing problems.

DE 10 2004 056 818 B3 discloses a rotary union whose rotating union part includes a sleeve. The rotating machine part comprises an axial hollow space with a hollow space insert. A bushing has an outer side adapted to the hollow space. The rotating machine part is supported over bearings which permit a certain pivoting of the axis end. The bushing of the hollow space insert is constructed with a spherical inner side. The sleeve of the rotating union part is constructed with an outer diameter which corresponds to the smallest diameter of the spherical inner side of the bushing. In this construction, the sealing means between the non-rotating and rotating machine parts is effective in a radial plane to the axis of the rotating machine part, and can be displaced relative to each other, while they simultaneously rotate relative to each other. If, in the event of strong loads, the rotating machine part bends through and the axis end swings, the rotating union part can be roiled on the spherical inner side of the bushing by the value of the angle error, so that the rotating machine part remains parallel to the axis and there is no edging of the sealing means in the radial sealing plane. Consequently, a uniformly good sealing effect in the radial sealing plane is to be expected. The rotary union disclosed in DE 10 2004 056 818 B3 is constructed as a rotary union which is flanged onto the front side.

However, it is frequently not possible to mount connections at the front sides. Especially in the case of large shafts in drive technology, particularly in roll drives, radially rotating passages are obtained which make it possible to facilitate a media introduction from outside into the shaft, for example, onto a shaft to which a toothed joint spindle is hinged. In that case, a stationary union part has a supply ring which is supported by a slide bearing relative to a union part rotatable in the interior of the stationary union part. As a result of a radial supply, a lubricant enters through the supply ring into a hollow space between the two rotary union parts and out of the hollow space through a hollow space extending in the rotary union part into the interior thereof.

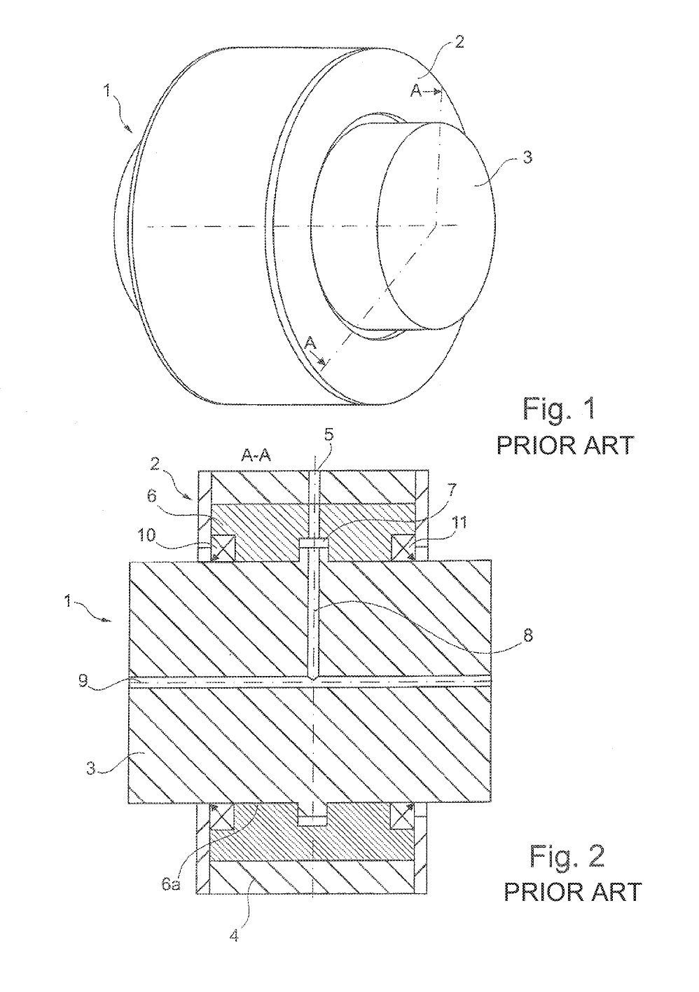

Such a rotary union 1 (in FIG. 1 in a perspective view and in FIG. 2 in a sectional view corresponding to a sectional line A-A illustrated in FIG. 1) in accordance with the prior art includes a union part 2 that is fixed to the device and radially surrounds a rotary union part 3, i.e., a shaft in the manner of a jacket. A radially directed media supply line 5 is mounted in the housing 4 of the rotary union part 2, wherein the media supply line extends in the radial direction through a slide ring 6 which rotates together with the housing 5 and which supplies a medium to a chamber 7 which surrounds the rotary union part 3 in the manner of a ring. Through a media supply line 8 extending radially and rotating with the rotary union part 3, the hollow chamber 7 is connected to a media supply line 9 extending in the direction of the longitudinal axis of the rotary union part 3. The sliding ring 6 forms together with the jacket surface of the rotary union part 3 a lubricating gap 6a having a height of about 0.5 mm and sealed toward the outside by means of seals 10, 11, mounted on the rotary union part 3. In this construction, a relatively large play must be accepted between the sliding ring 6 and the rotary union part 3 which does not permit the buildup of a high lubricant pressure.

The disadvantage of this known solution and of other known solutions is the fact that a play always exists between the bearing and the shaft. Another disadvantage is the consumption of the own lubricant of the bearing. Other disadvantages are the temperature increase of the media used during the operation as well as the sealing problems caused by the large play between the rotating and the stationary rotary union parts.

It is the object of the invention to avoid the disadvantages of the prior art and to additionally provide the possibility of using seals for higher pressures, in particular for pressures of more than 2 bar.

In accordance with the invention, this object is met by a rotary union of the above-described type by providing individual support bearings which determine the radial distance between the stationary union part and the rotating union part.

As a result, instead of the revolving support as it is known in accordance with the prior art, only dot-like support elements are required which leads to a significantly lower development of frictional heat in comparison to the prior art. The disadvantages of the prior art are overcome by the invention. The invention makes it possible to mount a functionally reliable rotary union in a flat-neck-spindle.

Advantageous further developments of the invention result from the dependent claims.

It has been found to be advantageous if the support bearings are constructed as support rollers. Due to the use of support rollers, a secure support of the rotating rotary union part relative to the stationary rotary union part is achieved which, with high stability in the areas of the bearings instead of sliding friction, only cause rolling friction and, thus, a significantly lower heating of the cooling and lubricating medium than is the case in the prior art. In addition, at the pressures which are now possible, sealing means can be utilized which can only compensate limited running deviations, for example, of less than 0.2 mm.

Consequently, the actual running deviations between the rotary union and the shaft must be even significantly lower than this value. However, it has been found that such low running deviations during the use of the invention can be achieved. accordance with the invention, the weight of the stationary rotary union part of at least two rollers or roller pairs of the support rolls is transmitted onto the shaft in such a way that the seal built into the media supply rests precisely on the jacket wall of the shaft of the rotating rotary union part so that only a limited movability of the seal lips is required. Seals for higher pressures, which have only a low flexibility, can now be utilized.

The rollers or roller pairs which form the support rolls are independent of a lubrication by the lubrication medium which is to be conducted. This means that any chosen liquid or gaseous media can be conducted through with a rotary union according to the invention.

Preferably, the support rolls are guided by axles, shafts, hubs and/or by guiding means at the front side, particularly by collars.

In accordance with the basic principle of the invention, in a radial plane at an outer supply ring for the media supply at least two support rolls are arranged above the shaft axis of the rotating rotary union part which is supported relative to the non-rotating rotary union part.

Alternatively, the at least two support rolls are arranged at an acute or obtuse angle relative to each other.

In accordance with the particularly preferred configuration of the invention, three support rollers, particularly in equal spacings relative to each other, are provided. In principle, the bearing can take place symmetrically or asymmetrically.

By the use of a pretension without play, for example, of the roller bearings of the support rolls, a play-free running of the rotating rotary union parts can be achieved with precise round rotation.

Moreover, it can be provided that the support rolls are each integrated in a housing which supports them, in particular in a carriage.

The support bearings can be arranged inside or outside of the space through which the media flows.

The invention also relates to a drive unit, particularly a roll drive, with a rotary union part as it is illustrated in accordance with the invention, in particular with the aid of the following description.

In the following, the invention will be explained in more detail with the aid of an embodiment.

In the drawing:

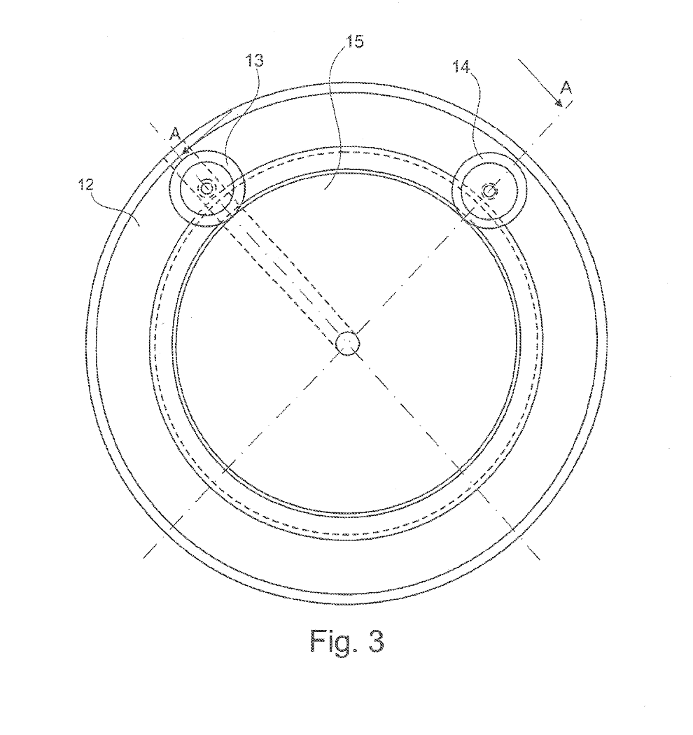

FIG. 3 shows a lateral top view of a first embodiment of a rotary union whose rotary union part attached fixedly to the device is supported through two support rollers relative to the rotating rotary union part;

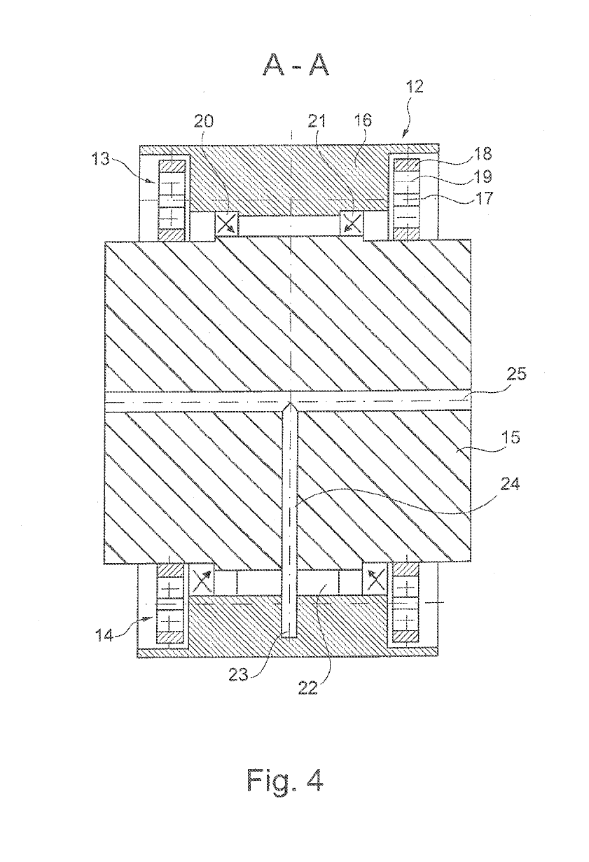

FIG. 4 is a sectional view of the rotary union of FIG. 3 along a sectional line A-A;

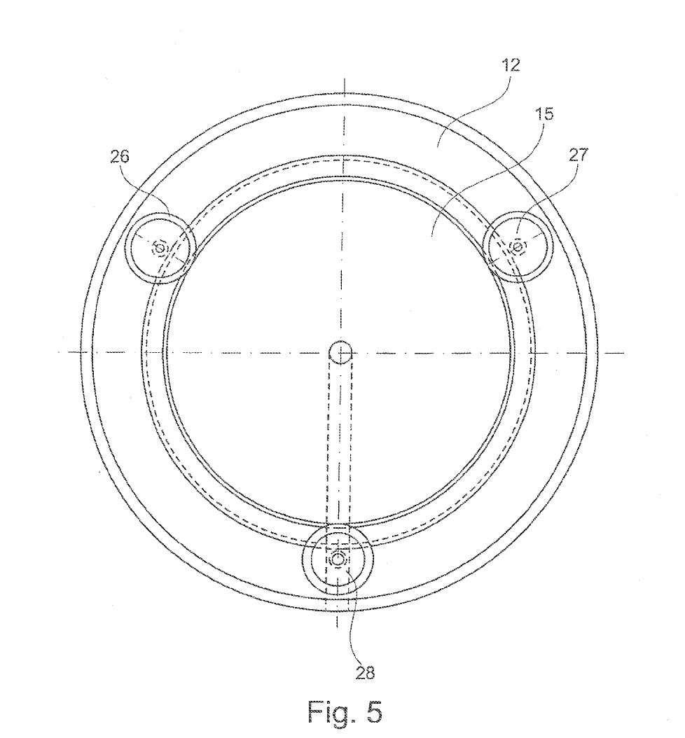

FIG. 5 shows a lateral top view of another embodiment of a rotary union whose rotary union part fixedly attached to the device is supported through three support rollers with equal spacings against which the rotating rotary union part is supported;

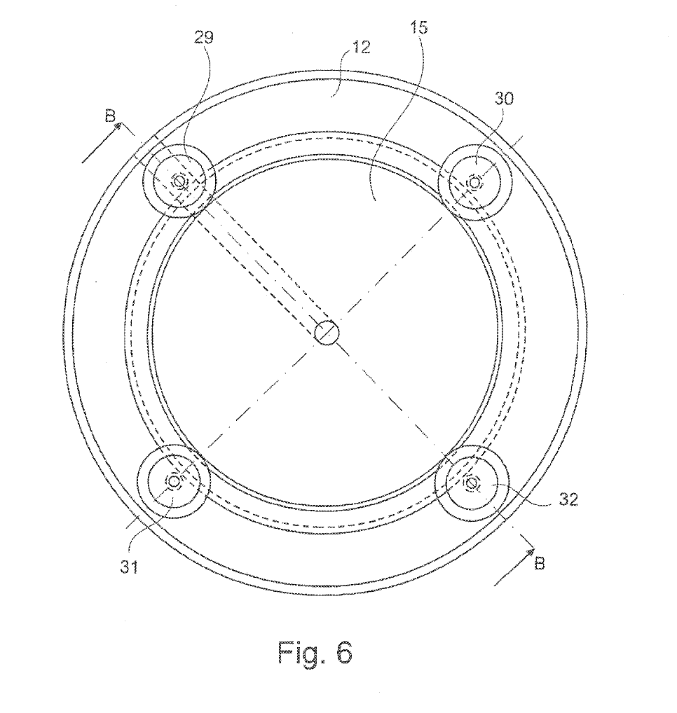

FIG. 6 is a lateral view of a third embodiment of the invention in which four equally spaced support rollers support the non-rotating rotary union part relative to the rotating rotary union part;

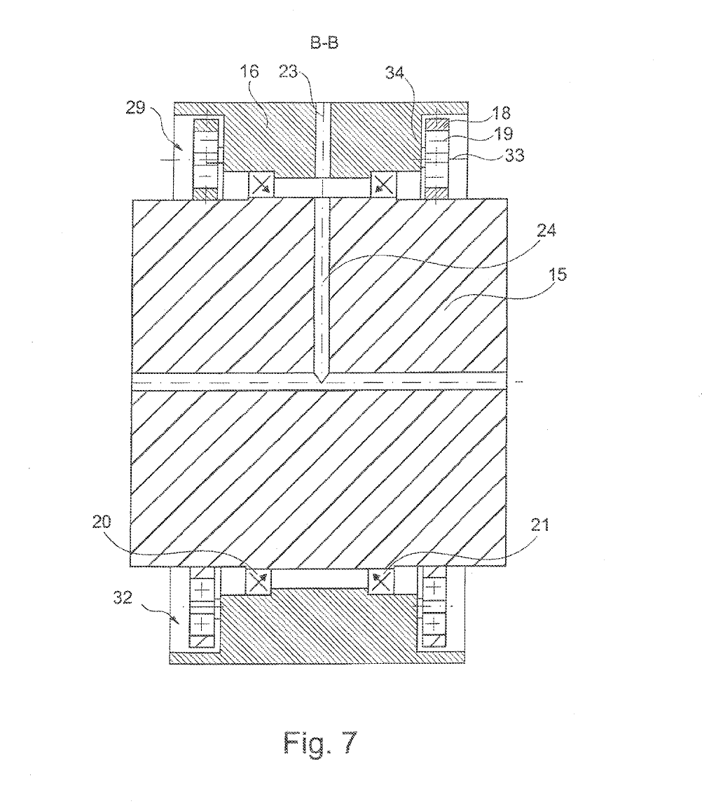

FIG. 7 shows a sectional view of the third embodiment according to FIG. 6 along a sectional line B-B;

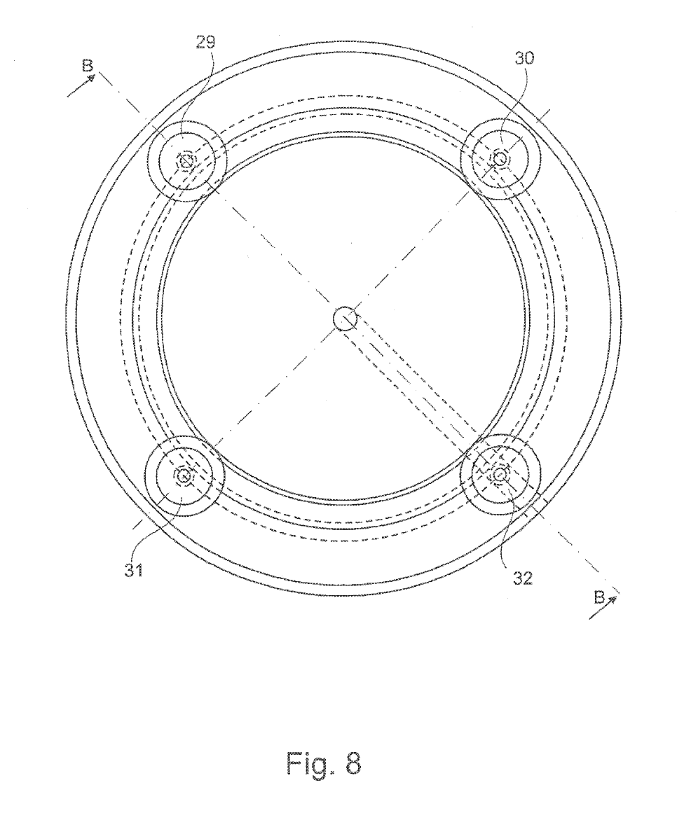

FIG. 8 shows a variation of the third embodiment in a lateral view; and

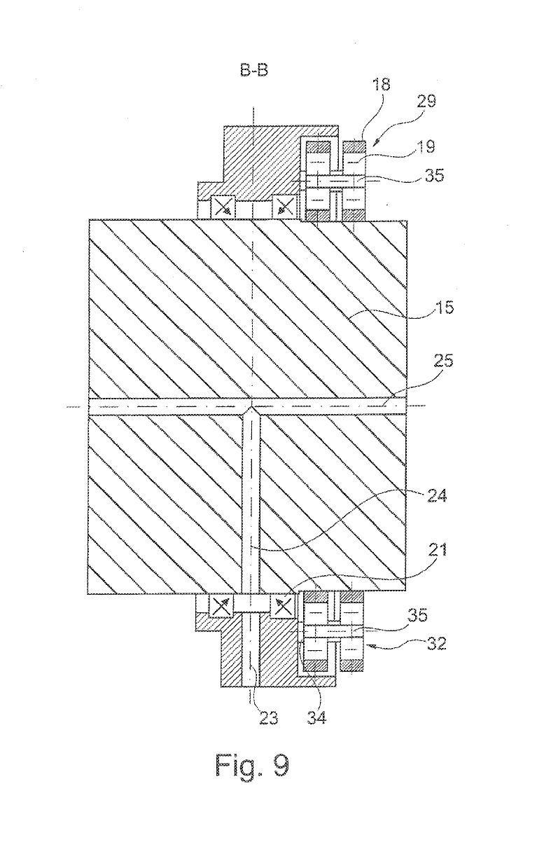

FIG. 9 shows a sectional view of the variation according to FIG. 8 along sectional line B-B.

In a first embodiment of the invention (FIGS. 3, 4), a rotary union has a union part 12 fixed to the device, which is supported through two pairs of support rollers 13, 14 mounted at an end in the rotary union part 12, relative to a rotating rotary union part 15. The two pairs of support rollers 13, 14 are arranged at a right angle relative to each other. Through a shaft or through lateral fixing means, the positions of the support rollers 13, 14 are secured relative to a housing part 16 of the rotary union part 15. Between a roller axis 17 and a jacket part 18 is provided an annular bearing 19 each.

The support rollers 13, 14 are located outside of the annular hollow space 22 sealed by sealing means 20, 21, wherein the hollow space 22 surrounds the rotary union part 15. In the housing part 16 is mounted a media supply 23 which leads to the hollow space 22. From there a medium serving for lubricating and/or cooling is conducted further in a radially extending duct 24 in the interior of the rotary union part 15. The duct 24 ends in a channel 25 extending in the direction of the longitudinal axis of the rotary union part 15.

A second embodiment of a rotary union according to the present invention (FIG. 5) is constructed in a similar manner. In this case, three support rollers 26, 27 and 28 are provided which are arranged at equal spacings, so that the center points form the corner of an equilateral triangle. As a consequence, this construction has the advantage over the constructions illustrated in FIGS. 3 and 4, in which the stability of the construction is only defined by the own weight of the stationary rotary union part, that a more uniform running is ensured. By changing the axial position of the support rollers 26, 27 and 28, it is even possible to adjust a play-free running of the rotary union part 12, and thus, the seals 20, 21 relative to the rotary union part 15.

Another embodiment (FIG. 6, 7) of a rotary union comprises four support rollers 29, 30, 31 and 32 whose center points from the corners of a square. In contrast to the embodiment illustrated in FIG. 3, the axis of the support rollers 29, 30, 31 and 32 is formed by a shaft 33 (FIG. 7) which is supported through a roll neck or a running flange 34 laterally relative to the housing part 16. This embodiment otherwise does not differ in construction from those of FIGS. 3-5. An advantage of this embodiment resides in the fact that greater axial forces can be transmitted.

In a last embodiment (FIGS. 8, 9), in a rotary union part 12 which also contains four pairs of support rollers 29 to 32, the pairs of the support rollers 29 through 32 are mounted in contrast to the embodiments described above, opposite each other on both sides of the rotary union part 12 but next to each other and connected through a common shaft 35 on one of the two end faces. As in the other embodiments, the support rollers 29 through 32 are located outside of the housing part 16. It is understood that in the further development of the support rolls 29 through 32 as twin rollers, the 180° opposed support rollers 29 and 31 are for example arranged on one end face and the two 180° opposed support rollers 30 and 31 are arranged on the other end face.

This embodiment has the advantage that the seals 20, 21 are each more easily accessible. In addition, this embodiment can also be used in narrow space conditions. In accordance with the invention, it is also possible to use support rollers whose jacket parts 18 have a spherical, i.e., convex outer contour, and roll in appropriately shaped contours of the two rotary union parts.

In all embodiments, the rotary union part 12, fixed to the device, is supported relative to the stationary structural components by a torque support.

### REFERENCE NUMERALS

1 Rotary union
2 Rotary union part fixed to the device
3 Rotatable Rotary union part
4 Housing
5 Media supply line
6 Sliding ring
6a Lubricant gap
7 Chamber
8 Media supply line
9 Media line
10 Seal
11 Seal
12 Rotary union part fixed to the device
13 Support roll
14 Support roll
15 Rotatable Rotary union part
16 Housing part
17 Axis
18 Jacket part
19 Annular bearing
20 Seal
21 Seal
22 Hollow space
23 Media supply
24 Media Duct
25 Media Channel
26 Support roll
27 Support roll
28 Support roll
29 Support roll
30 Support roll
31 Support roll
32 Support roll
33 Shaft
34 Running collar
35 Shaft

1-10. (canceled)

11. A rotary union for supplying and/or removing a pressurized medium into or from an axial hollow space of a rotating machine part, comprising: a fixed, non-rotating rotary union part; a rotating rotary union part; and bearing means and sealing means that are active in radial sealing planes between the rotating rotary union part and the fixed rotary union part, wherein the bearing means are point support bearings which determine a radial distance between the fixed, non-rotating rotary union part and the rotating rotary union part.

12. The rotary union according to claim 11, wherein the support bearings are constructed as support rollers.

13. The rotary union according to claim 12, wherein the support rollers are guided by axles, shafts, hubs and/or front end guide means.

14. The rotary union according to claim 13, wherein the support rollers are guided by collars.

15. The rotary union according to claim 13, wherein at least two support rollers are arranged in a radial plane above a shaft axis of the rotating rotary union part, which is supported relative to the non-rotating rotary part.

16. The rotary union according to claim 15, wherein the support rollers are arranged at an acute angle or an obtuse angle relative to each other.

17. The rotary union according to claim 16, wherein three support rollers.

18. The rotary union according to claim 17, wherein the support rollers are equally spaced relative to each other.

19. The rotary union, according claim 11, wherein the support bearings are under pretension.

20. The rotary union, according to claim 12, wherein the support rollers are each integrated in a housing supporting them.

21. The rotary union according to claim 20, wherein the housing is a carriage.

22. The rotary union, according to claim 12, wherein the support bearings are arranged within or outside of a space through which the medium flows.

23. A drive unit, comprising a rotary union for supplying and/or removing a pressurized medium into or from an axial hollow space of a rotating machine part, the rotary union including a fixed, non-rotating rotary union part, a rotating rotary union part, and bearing means and sealing means that are active in radial sealing planes between the rotating rotary union part and the fixed rotary union part, wherein the bearing means are point support bearings which determine a radial, distance between the fixed, non-rotating rotary union part and the rotating rotary union part.
